(19) United States
(12) Patent Application Publication
(10) Pub. No.: US 2026/0093480 A1
(43) Pub. Date: Apr. 2, 2026

(54) SYSTEMS AND METHODS FOR CODE GENERATION AND CODE CONVERSION

(71) Applicant: BANK OF MONTREAL, Toronto (CA)

(72) Inventors: Yagni DESAI, Mississauga (CA); Jimmy GEORGE, Caledon East (CA); Carl GOMES, Toronto (CA); Kasthuri THIRU, Markham (CA); Sankar SUBBIAH, Toronto (CA); Liang WANG, North York (CA)

(73) Assignee: BANK OF MONTREAL, Toronto (CA)

(21) Appl. No.: 19/347,095

(22) Filed: Oct. 1, 2025

Related U.S. Application Data
(60) Provisional application No. 63/702,505, filed on Oct. 2, 2024.

(51) Int. Cl. G06F 8/70

(52) U.S. Cl. CPC G06F 8/70

(57) ABSTRACT

A computer-implemented method for code management comprises automatically receiving, by one or more processors from a first computing device, a first template comprising a plurality of matrices in a first format for use by a generation system to generate a second template in a second format for a second computing device; executing, by the one or more processors, a protocol on a first matrix of the plurality of matrices; parsing, by the one or more processors, a second matrix of the plurality of matrices to generate a value for the target field by using the transformation rules on the code of the source field; and generating, by the one or more processors via the generation system using the parsed first matrix and the parsed second matrix, the second template including the value for the target field in the second format used by the second computing device.

### CROSS-REFERENCE TO RELATED APPLICATIONS

This application claims priority to U.S. Provisional Patent Application No. 63/702,505, filed Oct. 2, 2024, which is incorporated herein by reference in its entirety for all purposes.

### TECHNICAL FIELD

This application relates generally to generating and converting codes for a cloud platform.

### BACKGROUND

As the processing power of computers allows for greater computer functionality and the Internet technology era allows for interconnectivity between computing systems, many organizations utilize sophisticated computing systems to support business logistics across entities. For instance, a bank can use sophisticated computing systems to manage business logistics associated with each client of the bank. Conventional computer-implemented methods can store the logistics of each entity within a spreadsheet shared between the bank and the respective entity.

Conventional software solutions and computer-implemented methods suffer from a technical shortcoming. For instance, even using state of the art storage techniques, conventional software solutions cannot maintain uniformity between each entity and the respective bank as these solution stores data separately. Storing the data separately utilizes more computing resources and significantly increases overhead. To address the abovementioned technical shortcoming, organizations are forced to have an administrator manually align codes for upload to a cloud server resulting in increased processing time, wasted computing resources, and high computational capacity.

### SUMMARY

Systems and methods described herein attempt to address the deficiencies of the conventional solutions. The systems and methods may receive a document, such as a spreadsheet, from a computing device. The spreadsheet document can include multiple tabs corresponding to business logistics of an entity that are in a format understood by the respective entity. The systems and methods may execute a computer code on a first tab to generate source destinations and map them to target destinations. From here the systems and methods may parse a second tab of the spreadsheet document to generate values for each of the target field by using one or more transformation rules. Ultimately, the systems and methods may generate a second spreadsheet document that includes the target values in another format for use by a cloud server. In this manner, the systems and methods described herein can automatically align codes for uploading to the cloud server thereby reducing processing time, saving computing resources, and reducing computational capacity.

Embodiments disclosed herein provide solutions to the aforementioned problems and provide other solutions as well. In an embodiment, a computer-implemented method for code management comprises automatically receiving, by one or more processors from a first computing device, a first template comprising a plurality of matrices in a first format for use by a generation system to generate a second template in a second format for a second computing device, the first template defining transformation rules for a code associated with the first computing device; executing, by the one or more processors, a protocol on a first matrix of the plurality of matrices, the protocol to parse the first matrix of the plurality of matrices to generate a source field corresponding to the code and a target field; parsing, by the one or more processors, a second matrix of the plurality of matrices to generate a value for the target field by using the transformation rules on the code of the source field; generating, by the one or more processors via using the parsed first matrix and the parsed second matrix, the second template including the value for the target field in the second format used by the second computing device, wherein the value for the target field of the second computing device corresponds to the code of the source field of the first computing device; and providing, by the one or more processors, the second template in the second format to an external server accessible to the first computing device and the second computing device, the second format mapped to the first format such that the first computing device extracts the value for the target field from the second template.

The method may further comprise verifying, by the one or more processors, a source address of the first computing device in accordance with one or more of certificate validation, application programming interface (API) key matching, or encrypted token response; and in response to successfully verifying the source address, transmitting, by the one or more processors, a response to the source address indicating an approval of the first template.

The method may further comprise preventing, by the one or more processors, the reception of the first template from the first computing device in response to a failure to verify the source address of the first computing device.

Executing the protocol may further comprise identifying, by the one or more processors, a presence of at least one placeholder within the first matrix by use at least one look-up table to identify an empty value in one or more fields of the first matrix; and identifying, by the one or more processors, the code within the one or more fields of the first matrix in accordance with a mapping function.

The method may further comprise determining, by the one or more processors, a mapping from the source field of the first matrix to a target field of the second matrix using a code history of each matrix stored within a data repository.

The method may further comprise generating, by the one or more processors, the target field in a format defined by the second template based on the mapping; inserting, by the one or more processors, a second value as a placeholder within the target field; and generating, by the one or more processors, a mapping table that maintains the second value and includes an indication that maps the second value to at least one transformation rule.

The method may further comprise assigning, by the one or more processors, the first matrix with an identifier by using one or more of a cryptographic hash, public keys, timestamps, and a version number; identifying, by the one or more processors, an update to the first matrix based on a third template include a third matrix that includes one or more values of a plurality of values within the first matrix and a plurality of placeholders; and updating, by the one or more processors, the first matrix to include the plurality of values and each of the plurality of placeholders of the third matrix.

The method may further comprise modifying, by the one or more processors, the identifier of the first matrix in accordance with the update.

The method may further comprise generating, by the one or more processors, a value for the target field by using at least one transformation rule on the code of the source field.

The method may further comprise generating, by the one or more processors, a data structure that includes a mapping log for the source field mapped to the target field, the mapping log including a key-value pair corresponding to the code of the source field and the value of the target field.

The method may further comprise causing, by the one or more processors, a server to upload the second template to at least one layer of a cloud framework.

The method may further comprise receiving, by the one or more processors from a plurality of computing devices, a plurality of templates comprising the plurality of matrices in at least one format; for each template in the plurality of templates, loading, by the one or more processors, a queue based on one or more of a size of a template, an estimated time to process the template, a reception time of the template, and a priority assigned to the template; and executing, by the one or more processors in accordance with the queue, a protocol on a matrix of the plurality of matrices, the protocol to parse the matrix to generate a second source field corresponding to second code and a second target field.

The second format may comprise at least one of Comma Separated Values (CSV), JavaScript Object Notation (JSON), Parquet, Avro, Optimized Row Columnar (ORC), or database storage formats accessible using Java Database Connectivity (JDBC).

In another embodiment, a system of code management comprises one or more processors coupled with memory, the one or more processors configured to: receive, from a first computing device, a first template comprising a plurality of matrices in a first format to generate a second template in a second format for a second computing device, the first template defining transformation rules for a code associated with the first computing device; execute a protocol on a first matrix of the plurality of matrices, the protocol configured to parse the first matrix of the plurality of matrices to generate a source field corresponding to the code and a target field; parse, using the protocol, a second matrix of the plurality of matrices to generate a value for the target field by using the transformation rules on the code of the source field; generate, using the parsed first matrix and the parsed second matrix, the second template including the value for the target field in the second format used by the second computing device, wherein the value for the target field of the second computing device corresponds to the code of the source field of the first computing device; and provide the second template in the second format to an external server accessible to the first computing device and the second computing device, the second format mapped to the first format such that the first computing device extracts the value for the target field from the second template.

The one or more processors may be further configured to: verify a source address of the first computing device in accordance with one or more of certificate validation, application programming interface (API) key matching, or encrypted token response; and in response to successfully verifying the source address, transmit a response to the source address indicating an approval of the first template.

The one or more processors may be further configured to prevent the reception of the first template from the first computing device in response to a failure to verify the source address of the first computing device.

The one or more processors may be further configured to identify a presence of at least one placeholder within the first matrix by use at least one look-up table to identify an empty value in one or more fields of the first matrix; and identify the code within the one or more fields of the first matrix in accordance with a mapping function.

The one or more processors may be further configured to determine a mapping from the source field of the first matrix to the target field of the second matrix using a code history of each matrix stored within a data repository.

The one or more processors may be further configured to generate the target field in a format defined by the second template based on the mapping; insert a second value as a placeholder within the target field; and generate a mapping table that maintains the second value and includes an indication that maps the second value to at least one transformation rule.

The one or more processors may be further configured to assign the first matrix with an identifier by using one or more of a cryptographic hash, public keys, timestamps, and a version number; identify an update to the first matrix based on a third template include a third matrix that includes one or more values of a plurality of values within the first matrix and a plurality of placeholders; and update the first matrix to include the plurality of values and each of the plurality of placeholders of the third matrix.

### BRIEF DESCRIPTION OF THE DRAWINGS

FIG. 1 illustrates components of a code management system, according to an embodiment.

FIG. 2 illustrates a flow diagram of a process executed by the code management system.

FIG. 3 illustrates a flow diagram of a process executed by the code management system for code generation, according to an embodiment.

FIG. 4 illustrates a flow diagram of a process executed by the code management system for code conversion, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

The systems and methods described herein can provide several technical benefits to the functioning of computer systems. For example, by automatically extracting and applying transformation rules to generate values for target fields, the systems and methods described herein can reduce the need for manual code mapping by an administrator. The automatic application of the transformation can further reduce network load and error related to entries. In this manner, a computing system can benefit from enhancing computational efficiency by reducing CPU cycles that would normally be involved with the revisions of the entries.

Automation for the computing system can parse multiple matrices to extract code history, apply rules, and generate a new template in a plurality of structured formats (e.g., Comma-Separated values (CSV), JavaScript Object Notation (JSON), Parquet, Spark SQL, etc.). Furthermore, a plurality of ETL stages can be automated to improve execution time to parse the matrices. By performing the ETL processes at the generation of the templates, the computing system can reduce latency in the ETL cloud framework and improvs the scalability of multi-computing device requests.

The systems and methods described herein can generate code mapping between source and target formats. The code mappings can allow various client computing systems to transmit, receive, or otherwise store data in a standardized format. The code mappings eliminate the need to transform source formats into a target format and vice versa thereby, reducing the likelihood of including redundancy of data, duplicate entries, and null data within a data repository or a cloud server.

The systems and methods described herein can receive and process templates in a plurality of formats (e.g., HTML, Excel, Word, PDF, CSV, JSON, Parquet). Using the templates, a server can normalize each of the formats without a need for execution of mismatch formats which would cause excess computer utilization and increased latency when attempting to integrate heterogeneous files. By normalizing the formats into a singular representation, the server can reduce latency and further automate integration of heterogeneous files. Furthermore, the generation of subsequent templates allow for compatibility with various cloud ETL frameworks to further shorten deployment cycles and reduce the number of conversion stages.

The templates can include null, empty, or stale values. The server can execute placeholder indexing to populate each of the placeholders (e.g., null, empty, stale values) with predefined values or values computed by the server. By using placeholder indexing, the server can reduce data gaps in a target system, increase data completeness, and reduce downstream errors that can occur when the target system executes a query of in the event the dataset is used for machine learning.

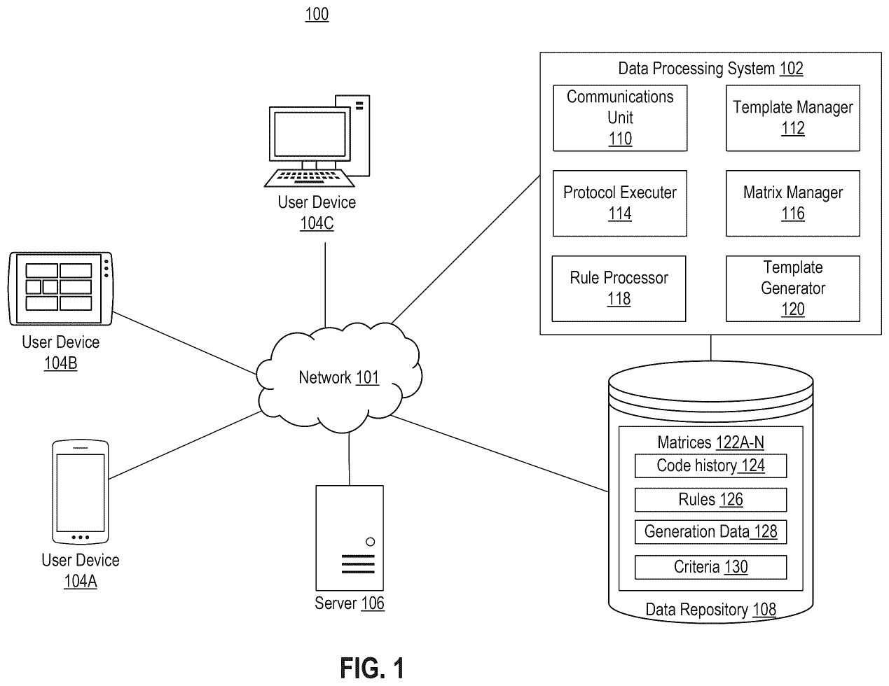

FIG. 1 illustrates components of a code management system 100 (referred to as system 100 herein). The system 100 can include a data processing system 102, a user device 104 (e.g., user device 104A, user device 104B, user device 104C), a server 106, and a data repository 108. The above-mentioned components may be connected to each other through a network 101. The examples of the network 101 may include, but are not limited to, private or public LAN, WLAN, MAN, WAN, and the Internet. The network 101 may include both wired and wireless communications according to one or more standards and/or via one or more transport mediums.

The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Global System for Mobile Communications), CDMA (Code Division Multiple Access), EDGE (Enhanced Data for Global Evolution) network.

In further detail, the data processing system 102 (sometimes herein generally referred to as a preference system) may be any computing device comprising one or more processors coupled with memory and software and capable of performing the various processes and tasks described herein. The data processing system 102 may be in communication with the one or more user devices 104, the server 106, and the data repository 108 via the network 101. The data processing system 102 may be situated, located, or otherwise associated with at least one computer system. The computer system may correspond to a data center, a branch office, or a site at which one or more computers corresponding to the data processing system 102 are situated.

The data processing system 102 can include at least one communications unit 110, a template manager 112, a matrix manager 116, a rule processor 118, a protocol executer 114, and a template generator 120. The communications unit 110 can receive instructions, data packets, signals, requests, among others, from the server 106 and the user devices 104 of the network 101. The template manager 112 can analyze the received documents (e.g., spreadsheet) from the user devices 104. The matrix manager 116 can manage data associated with the tabs of the documents. The rule processor 118 may apply one or more transformation rules to the codes of the spreadsheet documents. The protocol executer 114 can execute protocols on the tab of the spreadsheet document. The template generator 120 can generate more spreadsheet documents in accordance with the previous spreadsheet documents.

The user devices 104 (sometimes herein referred to as an end user computing device) may be any computing device comprising one or more processors coupled with memory and software and capable of performing the various processes and tasks described herein. The user device 104 may be in communication with the data processing system 102 and the data repository 108 via the network 101. The user device 104 may be a smartphone, other mobile phone, tablet computer, wearable computing device (e.g., smart watch, eyeglasses), or laptop computer. The user device 104 may access applications downloaded and installed (e.g., via a digital distribution platform), web applications with resources accessible via the network 101.

The server 106 may be any computing device comprising a processor and non-transitory machine-readable storage capable of executing the various tasks and processes described herein. Non-limiting examples of such computing devices may include workstation computers, laptop computers, server computers, laptop computers, and the like. While the system 100 includes a server 106, in some configurations, the server 106 may include any number of computing devices operating in a distributed computing environment. The server 106 may be configured to access and extract data from within the data repository 108.

The data repository 108 may store and maintain various resources and data associated with the school districts, libraries, geographical location, among others. The data repository 108 may include a data repository management system (DBMS) to arrange and organize the data maintained thereon, such as the school districts, libraries, geographical location, among others. The data repository 108 may be in communication with the data processing system 102 and server 106. While running various operations, the server 106 and the data processing system 102 may access the data repository 108 to retrieve identified data therefrom.

The data repository 108 can include matrices 122A-N (generally referred to as matrices 122 or as a matrix 122). Each matrix 122 can include a code history 124, rules 126, generation data 128, and criteria 130. The code history 124 can indicate revisions to the tabs of the spreadsheet document. The rules 126 can indicate transformation rules from a source tab to a target tab for each field of the spreadsheet document. The generation data 128 can indicate extract, transform, and load (ETL) process related to the matrix 122. The criteria 130 can indicate build criteria and join relationships for the ETL process.

The system 100 is not confined to the components described herein and may include additional or alternate components, not shown for brevity, which are to be considered within the scope of the embodiments described herein.

Referring still to FIG. 1, the user device 104 can transmit a first template (e.g., Excel, Word Document, PDF Document, Google Sheets, Microsoft Lists, and the like) to the data processing system 102 over the network 101. To transmit the first template, the user device 104 can first transmit a request to the data processing system 102. The request can include data packets for the communications unit 110 to prepare the data processing system for the reception of the template. For instance, the data packet can indicate the size of the template, the format of the template, metadata associated with the template, source address of the user device, destination address, etc. The request can be in response to an interaction at a user interface of the user device 104. In some embodiments, the user device 104 can correspond to an external entity and can transmit a request to the data processing system 102. The request can include a plurality of documents, files, reports, among other files to be standardized using the systems and methods described herein. In this manner, the user device 104 can standardize files in accordance with an entity hosting the data processing system 102.

In response to a successful verification of the user device, the communications unit 110 can approve of the request (including the template) by transmitting a response to the user device 104 at the source address. The communications unit 110 can verify the source address of the user device 104 to determine that the user device 104 is a client, entity, or user associated with the system 100. The communications unit 110 can perform one or more of certificate validation, API key matching, encrypted token response, or IP verification according to data within the data repository 108, among other forms of validation to verify the source address or the user device 104. For example, the communications unit 110 can verify that the user of the user device 104 is an employee of the entity associated with the system 100. Once approved, the communications unit 110 can receive the template from the user device 104 and transmit the template to the template manager 112. In some instances, the user device 104 can provide authentication credentials to the data processing system 102 to verify that the entity hosting the user device 104 is associated with the system 100. For example, a user device 104 can provide credentials (e.g., username and password, single sign on (SSO), badge identifier, biometric information, among other information to authenticate a user). The communications unit 110 can query the data repository 108 using the credentials. In response to the query identifying that the data repository 108 includes the provided credentials, the communications unit 110 can provide the acknowledgement response for receipt of the template. If the communications unit 110 indicates a failure to verify the authentication credentials, the communications unit 110 can prevent or block the reception of the template or the files from the user device 104 in response to an indication of incorrect authentication credentials.

In some embodiments, the user devices 104 can register with the system 100. Upon completion of registration, the data processing system 102 can generate and provide a private key to the registered user device 104. The private key can be unique to the registered user device. The registered user device can use the private key to log onto an interface associated with the provision of the templates. The data processing system 102 can generate and provide a public key for the user device 104. In this manner, the user device 104 can provide the public key to the data processing system 102 to authenticate the user device 104 prior to the reception of the template.

The template manager 112 can analyze the template from the user device 104 to identify the rules 126 (e.g., transformation rules) for code associated with the user device 104. The template manager 112 can perform at least one of schema validation, format detection, metadata extraction, or syntax verification, among other schemes to analyze a template to identify the rules 126. In the analysis, the template manager 112 can, for example, validate the structure of the template and validate the template for its compatibility to the data repository 108 (e.g., verify whether a similar template is present in the data repository). The rules 126 can correspond to mapping rules for the source fields of the matrices within the template. For example, a code within the source field of the template can include a flag. The flag can indicate a corresponding target field in a second template. The template manager 112 can extract the rules 126 from the data repository 108. For example, the user device 104 can transmit a plurality of templates to the communications unit 110. For each template, the data repository 108 can store and extract rules 126 that can be applicable to at least one template in the plurality of templates. In some embodiments, the template manager 112 can identify each matrix 122 within the template and store the matrix 122 within the data repository 108 for reference by the components described herein.

The template can include rules 126 for code associated with the user device 104 and a plurality of matrices in a format for use by the template generator 120. In some instances, the template manager 112 can convert each of the matrices 122 of the template into an intermediary format (e.g., XML, JSON). The intermediary format can pre-process the template to allow for standardized processing and generation of the second matrix 122. Upon registration of the user device 104, the template manager can generate or determine a plurality of mappings to map values or codes within the template to the data repository. The plurality of matrices can correspond to one or more tabs of a spreadsheet document, headings of a work document, sections of a PDF document, among others. For example, the template can be a spreadsheet document and each matrix 122 can correspond to each tab of the spreadsheet document. Each matrix 122 can include codes corresponding to one or more entities external to the system 100. The template manager 112 can execute one or more application programming interface (API) calls or schema validation functions to verify the mapping of the codes from the external entities and the data repository 108. The schema validation can validate the types of each field within the matrix prior to the execution of the protocol by the protocol executer 114. The format of the codes can be understood by the computing devices of the external entities, however the server 106 may not include a unform format for the codes between the system 100 and the external entities. Therefore, the data processing system 102 can use the format of the codes to generate a subsequent spreadsheet document (e.g., second template) in a second format for the server 106.

The protocol executer 114 can execute a protocol (or algorithm) on a first matrix 122 122 of the plurality of matrices. The protocol can be a collection of script, code, or text executed using one or more commands. For instance, the protocol executer 114 can use a “run” command to execute the protocol. In another example, the protocol executer 114 can use a “compile” command to execute the protocol, in response to the reception of the template. The protocol can be written in Python, Java, C++, JavaScript, Ruby, among others. In some embodiments, the protocol executer 114 can execute the protocol on each matrix 122 of the plurality of matrices. During execution of the protocol, the protocol executer 114 can load the matrix 122 into/from the data repository 108 to identify or classify the each of the placeholders or codes using one or more of look-up tables or parsing rules (e.g., rules 126) among other methods to identify the codes. For example, the protocol can cause the protocol executer 114 to use a look up table to establish the presence of at least one placeholder within the first matrix 122 by identifying a NULL, empty, or stale value within one or more fields of the first matrix 122.

The protocol executer 114 can trigger the matrix 122 manager 116 to parse the matrix 122 based on the protocol. For example, to parse the matrix 122, the matrix manager 116 can identify each code within one or more fields of the matrix 122. The matrix manager 116 can use or execute a mapping process or mapping function to identify each of the codes. The mapping function can include static mapping, code history 124, or an algorithm that compares descriptors for the code based on the file of the matrix 122. For example, the matrix manager 116 can use static mapping to identify each code. The static mapping can cause the matrix manager 116 to access the code history 124 for each field of the matrix 122. The code history 124 can include one or more codes that were previously used in at least one field of the matrix 122. In some instances, the matrix manager 116 can execute a string matching algorithm for each of the codes within the matrix 122.

The code can correspond to a logic associated with the client or entity. Upon identification of the codes, the matrix manager 116 may generate source fields to house the codes. Each source field can correspond to the code of the entity in accordance with information within the request. In generation, the matrix manager 116 can extract metadata from the extracted code. The metadata can include criteria for the source field, a format for the source field, a mapping for value within the source field, among other information. The matrix manager 116 can generate the source field to provide a destination address within the matrix 122 of the template. For example, the source field can include at least one code specific to the entity and an address corresponding to a second matrix 122 within the plurality of matrices from the entity.

While parsing the matrix 122, the matrix manager 116 can store the matrix in the data repository 108122. The matrix manager 116 can obtain the code history 124 from the matrix 122. The code history 124 can indicate revisions to the matrix 122 over a time period. For example, the code history 124 can show updates to a matrix within a spreadsheet document over the period. The matrix manager 116 can use the code history 124 of each matrix 122 in the data repository 108 to determine a mapping from the source field to a target field. For example, a user device 104 associated with an entity can receive a matrix that includes a plurality of codes from the data processing system 102. Each of the plurality of codes can be stored within the code history 124 of the data repository 108. A second user device 104 from the entity can provide a template to the data processing system 102 that includes a subset of the plurality of codes in the matrix. From here, the matrix manager 116 can detect a match between a code in the matrix and a code in the template. Based on the match, the matrix manager 116 can determine a mapping from a source field in the matrix to a target field of the template. The target field can include a NULL or empty value in a format defined by a generated template described herein. The matrix manager 116 can generate the target field in a respective format by using the determined mapping. For example, the matrix manager 116 can use the mapping from the source field to a target field based on the code history 124 of the spreadsheet document. From here, the matrix manager 116 can generate the target field in a format for a generated template and insert the NULL values as a placeholder for the target field. For each inserted NULL value, the matrix manager 116 can generate or determine a mapping table configured to maintain, store, or otherwise house each NULL value and includes an indication that maps the NULL value to the corresponding rule 126.

In storing, the matrix manager 116 can assign or indicate each matrix 122 with unique identifier to reduce the occurrence of redundancy and improve version handling within the data repository 108. For example, the unique identifier can correspond to or include a hash (e.g., cryptographic hash, hash map, hash key, content addressing hashes, or checksums, etc.), public keys, timestamps, or version numbers, among others. By using the unique identifier, the matrix manager 116 can detect or identify updates to a previously uploaded template (e.g., second matrix 122). For example, a received first matrix 122 can include values that are within, context associated with, or a relation to a previously generated matrix 122 for a user device 104. Instead of generating a new matrix or template, the matrix manager 116 can update the previously generated matrix 122 to populate the placeholders and NULL values. Concurrently, the matrix manager 116 can modify the unique identifier to correspond to the updates (e.g., version number, timestamp) while maintaining a link to the previous version of the matrix 122. In this manner, the systems and methods described herein can save computing resources (e.g., processing power, utilization), avoid unnecessary overwrites, and allow rollback to occur for the matrices 122.

The matrix manager 116 can parse the second matrix 122 of the template. The second matrix 122 can include criteria 130 that specifies build and join relationships for the ETL process of generating a new template. The criteria 130 can include extraction criteria such as time-based extraction and filter conditions. The time based extractions can include records that were created or modified in the code history 124. The time based extraction can be based on a time window that is defined by a predetermined time window or based on the revision time of a previous matrix 122 (e.g., calculating a delta). The filter conditions extract relevant data based on one or more specified conditions. The criteria 130 can include transformation criteria. The transformation criteria can include data cleaning, data standardization, data aggregation, data enrichment, among others. The criteria 130 can include loading criteria. The loading criteria 130 can include inserts, updates, batch loading, or real-time loading. The matrix manager 116 can automatically insert or map the build and join relationships into the second matrix 122 of the template using extracted metadata from the first matrix. The metadata can include criteria 130 for the first matrix 122 that can map to the second matrix 122, code history 124, generation data 128, among other metadata.

By using the criteria 130 of the second matrix 122, the matrix manager 116 can trigger the rule processor 118 to extract the rules 126 from the data repository 108 and apply the rules 126 to the code of the source field. By applying the rules 126 to the code, the rule processor 118 can generate a value for the target field to replace the NULL value. The value can include an equation, a number, logic, an algorithm, among others, which can be entered within the target field. For example, using the rules 126, the rule processor 118 can generate an equation for the target field. In another example, using the rules 126, the rule processor 118 can generate an algorithm for the target field. In this manner, the rule processor 118 can save computing resources by extracting and storing the rules 126 to map the source fields to the target fields.

In some embodiments, the matrix manager 116 can select or identify at least one rule 126 to apply to the code of the source field, in response to an indication of rules 126 correspond to the source field. The matrix manager 116 can select the rule 126 based on a context of the matrix 122, the criteria 130, most recent rule selected, a request by the user device 104, or previously generated templates from the user device 104, among other factors to select the rule. Each of the factors can include a priority for the selection of the rule. For example, the criteria 130 and the context of the matrix 122 can include a high priority, whereas the most-recent rule selected can include a low priority. In another example, the request from the user device can include a high priority, whereas previously generated templates can include a low priority.

Upon successfully parsing the second matrix, the template generator 120 can use the parsed first matrix 122 and the parsed second matrix 122 to generate the second template. The second template can be an Excel document, Word document, Spark SQL template file, among others. For example, the template generator 120 can generate a configuration and initialization template, loading data template, saving data template, SQL operations template, an ETL pipeline template, and the like. The template generator 120 can use generation data 128 to generate the second template. The generation data 128 can include metadata associated with the ETL process in at least one matrix 122 in the plurality of matrices 122. The generation data 128 can be at least one of source data, extraction data, transformation data, loading data, and resulting data. For example, the template generator 120 can use the generation data 128 to specify how to extract the data from the source fields within the first matrix 122.

The second template can include the values of the target field in a second format that is different from the first format, however, the second format can map to the first format by tracing the value of the target field to the code of the source field. Concurrently to the generation of the second template, the template generator 120 can generate or create a data structure (e.g., linked list, abstract data structure, array, etc.) that includes a mapping log for each target field to source field. The mapping log can include one or more identifiers indicating a relationship or tracing between the code of the source field and the value of the target field. The mapping log can include, for example, a plurality of hash codes that correspond to the source code, a key-value pair such that the source code is the key and the target field is the value, a plurality of pointers such that the source variable is the source code and the pointer is to the target field, among other examples. The second format can be at least one of Comma-Separated Values (CSV), JavaScript Object Notation (JSON), Parquet, Avro, Optimized Row Columnar (ORC), or other databases using Java Database Connectivity (JDBC), based on the storage associated with the second template. For example, the template generator 120 can generate the second template in a format (e.g., CSV, JSON, Parquet) for a Spark SQL. The Spark SQL can include script implemented in Python to extract the data from the second template in the format. The value of the target field can correspond to the code of the source field of the user device 104. In this manner, the second template can include a mapping of the value of the target field and the code of the source field to create a uniform code mapping for the client and the host of the system 100. By creating the uniform code mapping, the system 100 can save computing resources by preventing the need to manually generate code mapping documents which include errors to slow the ETL cloud framework.

In some embodiments, the template generator 120 can identify or select the second format for the second template. The template generator 120 can identify the second format using the request provided by the user. The request can include an indication or an identifier for the second format. For example, the user device 104 can indicate that the second format be in CSV format based on a selection at the user interface of the user device 104. In another example, the data repository 108 can include a collection or list of templates provided by the user device 104 (e.g., user device 104A). The template manager 112 can maintain a frequency of occurrence corresponding to each format of the collection of templates. Based on the format that includes the highest frequency of occurrence (in comparison to the other frequency of occurrences), the template generator 120 can generate the second template in the format corresponding to the highest frequency of occurrence.

In some embodiments, the data processing system 102 can receive a plurality of templates from the at least one user device 104 or a plurality of user devices 104. The template manager 112 can receive each of the plurality of templates and generate a queue for each of the templates. In this manner the template manager 112 can process each template individually by assigning a record lock on the individual template. In some instances, the template manager 116 can load the queue based on the size of the received template, an estimated time to process the template, a reception time, and a priority assigned to the template among other factors.

The template generator 120 can transmit the second template to the server 106 via the network. Upon reception of the second template, the template generator 120 can cause the server 106 to upload, transmit, or otherwise provide the second template to the ETL cloud framework. For example, the server 106 can upload the second template to a raw layer of the ETL cloud framework. The raw layer can ingest the second template prior to processing the values of the target fields within the second template. From here, the server 106 can move the second template to the transformation layer of the ETL cloud framework, thereby, cleaning, transforming, and enriching the values of the target fields of the second template. In this manner, each user device 104 can access the server 106 to download or extract the second template from the ETL cloud framework on demand. The second template in the standard (e.g., second) format can be mapped to the format of the first template provided by a first user device 104. Because the formats of each template are mapped, each computing device can extract, obtain, or otherwise identify values of target fields that are readable by a separate computing system (e.g., first computing device, second computing device. Using the system described herein, the system can allow for creation of uniform code between a client and an entity for storage within an ETL cloud framework with a minimal number of duplicates within the storage. Furthermore, computing resources are saved by reducing errors detected through the manual creation of uniform code.

### NON-LIMITING EXAMPLES

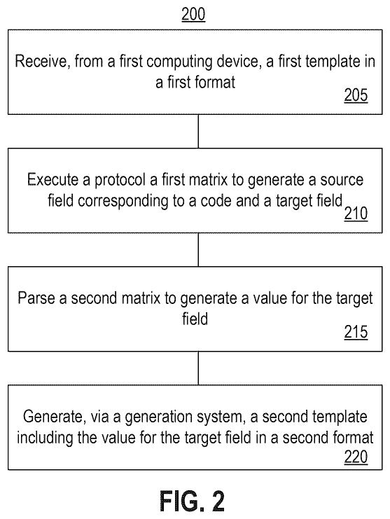

FIG. 2 illustrates a flow diagram of a process executed by the system 100. The method 200 includes steps 205-220. However, other embodiments may include additional or alternative execution steps or may omit one or more steps (or any part of the steps) altogether. The method 200 is described as being executed by one or more processors of a data processing system, similar to the one or more processors of the data processing system described in FIG. 1. However, one or more steps of method 200 may also be executed by any number of computing devices operating in the distributed computing system described in FIG. 1. For instance, one or more user computing devices may locally perform part or all the steps described in FIG. 1.

Even though some aspects of the embodiments described herein are described within the context of code management, it is expressly understood that methods and systems described herein apply to all cloud and storage systems. For instance, the method 200 may be used to manage data between a plurality of client systems.

A step 205, the one or more processors can receive from a computing device (e.g., user device 104A, user device 104B, user device 104C) a first template. The first template can be an Excel document, a Word document, a PDF document, a webpage, among others. The first template can define transformation rules for the code within the first template. The first template can correspond to the computing device that transmitted the first template. The computing device can correspond to an employee, a client, or an entity. The first template can include a plurality of matrices (e.g., matrices 122) in a first format. The first format can correspond to the order, arrangements, or sequence of codes within each matrix.

In a nonlimiting example, an employee of a computing device can transmit a spreadsheet document to a data center housing a data processing system (e.g., data processing system 102). Using a communications unit (e.g., communications unit 110), the data processing system can provide a template manager (e.g., template manager 112) with the spreadsheet document. From here, the template manager may analyze the spreadsheet document to identify a plurality of tabs (e.g., matrices 122) and rules 126 for each respective tab. Each tab can include code that corresponds to one or more business logistics associated with an entity of the spreadsheet document.

At step 210, the one or more processors (e.g., protocol executer 114) can execute a protocol on a first matrix of the plurality of matrices. The protocol can trigger the one or more processors (e.g., matrix manager 116) to parse the first matrix to generate a source field corresponding to the code within the first matrix and a target field. The source field can be a source address within the first matrix that includes code understood or interpreted by the computing device. The target field can be the destination address for a value or code in a second format understood by a server (e.g., server 106). The matrix manager can use a code history (e.g., code history 124) of the matrix to generate the target fields in accordance with the format of the previous version of the code.

In a nonlimiting example, a client can transmit a spreadsheet document to a data center housing the data processing system. A protocol executer can execute a protocol on a tab (e.g., matrix 122) of the spreadsheet document. From here, a matrix manager can parse the tab of the spreadsheet document. While parsing, the matrix manager can analyze the code within the tab to generate a source field for each code within the tab. Upon generation of the source field, the matrix manager can extract the code history from a data repository to generate the target field compatible with a format for the server. Because the target field does not include a value, the matrix manager can assign a NULL value to the target field. The NULL value can be a temporary value within the target field. The matrix manager can replace the NULL value with a generated value upon extraction of the rules.

At step 215, the matrix manager can parse a second matrix of the plurality of matrices. To parse the second matrix, the matrix manager can trigger a rule processor (e.g., rule processor 118) to extract the rules from the data repository associated with the code of the source field. Using the rules, the matrix manager can generate a value for the target field. The value for the target field can be an equation, an algorithm, a mapping, a collection of alphanumeric values, column logic, among others. Upon generation of the value, the matrix manager can replace the NULL value with the generated value.

In nonlimiting example, an employee can transmit a spreadsheet document to a data center housing a data processing system. After executing the protocol on a tab of the spreadsheet document, a matrix manager can parse a second tab by triggering a rule processor to extract and use transformation rules for code of a source field. From here, the matrix manager can generate column logic for the target field based on the transformation rules. In the event the tab of the spreadsheet document includes a plurality of source fields, the matrix manager can generate the value for each target field of the plurality of target fields.

At step 220, the one or more processors (e.g., template generator 120) can generate a second template. The template generator can use the parsed first matrix 122 and the parsed second matrix to generate the second template. The second template can include the value for each target field in a second format for use by the server. Each value within the second template corresponds to the code of the first template. In this manner, the template generator 120 can generate a template that includes uniform codes for the server and the computing devices.

In a nonlimiting example, a spreadsheet document can include multiple tables. A data processing system can parse a first tab to generate source field and target fields then parse a second tab to generate column logic for the target fields in accordance with codes associated with the source fields. Using the parsed first tab and the parsed second tab, a template generator can generate a Spark SQL template file for use by a server. The Spark SQL template file can include each column logic for the target fields, thereby, store uniform codes for use by the server. In this manner, the server can upload the uniform code for use by an extract, transform, and load (ETL) cloud framework.

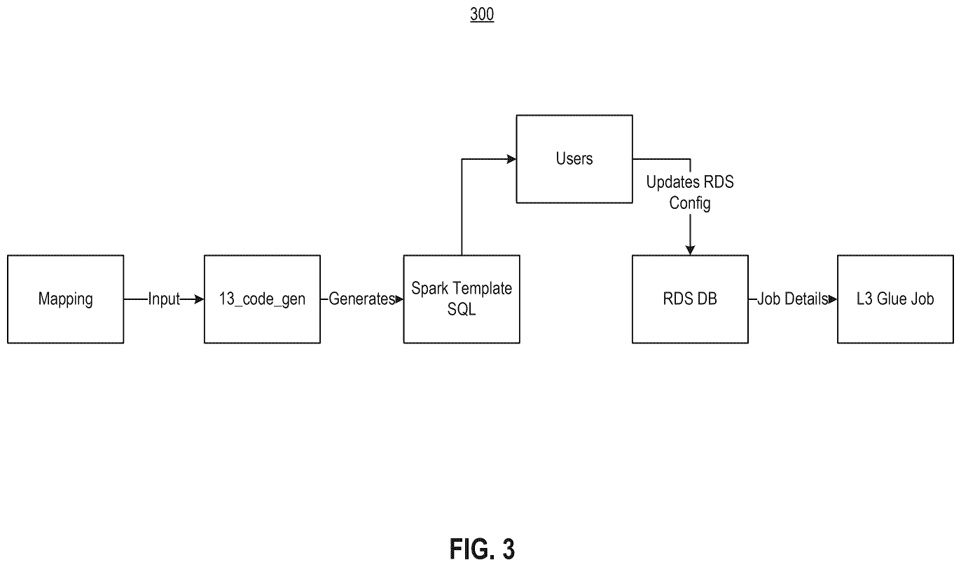

FIG. 3 illustrates a flow diagram of a process executed by the system 100 for code generation. The method 300 includes steps described herein. However, other embodiments may include additional or alternative execution steps or may omit one or more steps (or any part of the steps) altogether. The method 300 is described as being executed by one or more processors of a data processing system, similar to the one or more processors of the data processing system described in FIG. 1. However, one or more steps of method 300 may also be executed by any number of computing devices operating in the distributed computing system described in FIG. 1. For instance, one or more user computing devices may locally perform part or all the steps described in FIG. 1.

In a nonlimiting example, a computing device can house a spreadsheet document template that includes one or more ETL process and business transformation rules for the requirements of a business application. The template can include four sections such as revision history, mapping, entity relationships, and generic details. The revision history can capture an update history of the spreadsheet document. The mapping can state mapping transformation rules from a source table to a target table for each field. The entity relationships can define build criteria and join relationships for the ETL process. The generic details can capture all ETL process related details that are not within the mapping section or the entity relationship section. The spreadsheet document can be input into Python script. The Python script can read the entity relationships section and derive the source fields and transformations for the target field. Concurrently, the Python script can read the mapping section to derive target column logic in accordance with the source field. From here, the Python script can generate a Spark SQL template file for review by one or more administrators. The administrator can update configurations of the Spark SQL template file for a relational database service (RDS) database.

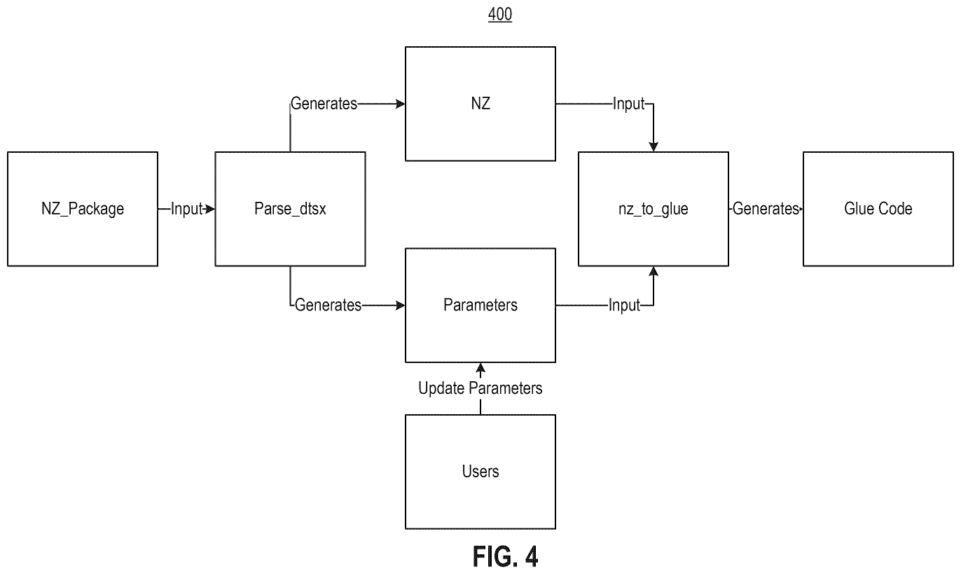

FIG. 4 illustrates a flow diagram of a process executed by the system 100 for code conversion. The method 400 includes steps described herein. However, other embodiments may include additional or alternative execution steps, or may omit one or more steps (or any part of the steps) altogether. The method 400 is described as being executed by one or more processors of a data processing system, similar to the one or more processors of the data processing system described in FIG. 1. However, one or more steps of method 400 may also be executed by any number of computing devices operating in the distributed computing system described in FIG. 1. For instance, one or more user computing devices may locally perform part or all the steps described in FIG. 1.

In a nonlimiting example, a computing device can house a file that is used by a SQL service integration system (SSIS). The file can be an On-Prem SSIS package consisting of extract, transform, and load (ETL) code that updates a Netezza database. The file can be input into a Python script for code conversion. The Python script can extract one or more parameters from the file for display as JavaScript Object Notation (JSON) at a user interface of a user device. An administrator can access the user interface to update the parameters of the JSON. Concurrently, the Python script can generate updates for the Netezza database by stripping out comments from SQL. The updates and the parameters can be fed into a second Python script to extract the sources (e.g., L1/L3 data) from the Netezza and generate Spark scripts for reading parquet. The second Python script can extract transformation SQL for the Netezza database to convert the transformation SQL to Spark SQL. The second Python script can extract targets from the Netezza and generate scripts in the form of parquet files. Furthermore, the second Python script can convert syntaxes of the SQL to a form supported by an ETL cloud framework.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded with the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of code management, comprising:
receiving, by one or more processors from a first computing device, a first template comprising a plurality of matrices in a first format to generate a second template in a second format for a second computing device, the first template defining transformation rules for a code associated with the first computing device;
executing, by the one or more processors, a protocol on a first matrix of the plurality of matrices, the protocol configured to parse the first matrix of the plurality of matrices to generate a source field corresponding to the code and a target field;
parsing, by the one or more processors using the protocol, a second matrix of the plurality of matrices to generate a value for the target field by using the transformation rules on the code of the source field;
generating, by the one or more processors using the parsed first matrix and the parsed second matrix, the second template including the value for the target field in the second format used by the second computing device, wherein the value for the target field of the second computing device corresponds to the code of the source field of the first computing device; and
providing, by the one or more processors, the second template in the second format to an external server accessible to the first computing device and the second computing device, the second format mapped to the first format such that the first computing device extracts the value for the target field from the second template.

2. The method of claim 1, further comprising:
verifying, by the one or more processors, a source address of the first computing device in accordance with one or more of certificate validation, application programming interface (API) key matching, or encrypted token response; and
in response to successfully verifying the source address, transmitting, by the one or more processors, a response to the source address indicating an approval of the first template.

3. The method of claim 2, further comprises preventing, by the one or more processors, the reception of the first template from the first computing device in response to a failure to verify the source address of the first computing device.

4. The method of claim 1, wherein executing the protocol further comprises:
identifying, by the one or more processors, a presence of at least one placeholder within the first matrix by use at least one look-up table to identify an empty value in one or more fields of the first matrix; and
identifying, by the one or more processors, the code within the one or more fields of the first matrix in accordance with a mapping function.

5. The method of claim 1, further comprises determining, by the one or more processors, a mapping from the source field of the first matrix to a target field of the second matrix using a code history of each matrix stored within a data repository.

6. The method of claim 5, further comprises:
generating, by the one or more processors, the target field in a format defined by the second template based on the mapping;
inserting, by the one or more processors, a second value as a placeholder within the target field; and
generating, by the one or more processors, a mapping table that maintains the second value and includes an indication that maps the second value to at least one transformation rule.

7. The method of claim 1, further comprising:
assigning, by the one or more processors, the first matrix with an identifier by using one or more of a cryptographic hash, public keys, timestamps, and a version number;
identifying, by the one or more processors, an update to the first matrix based on a third template include a third matrix that includes one or more values of a plurality of values within the first matrix and a plurality of placeholders; and
updating, by the one or more processors, the first matrix to include the plurality of values and each of the plurality of placeholders of the third matrix.

8. The method of claim 7, further comprises modifying, by the one or more processors, the identifier of the first matrix in accordance with the update.

9. The method of claim 1, further comprises generating, by the one or more processors, a value for the target field by using at least one transformation rule on the code of the source field.

10. The method of claim 1, further comprises generating, by the one or more processors, a data structure that includes a mapping log for the source field mapped to the target field, the mapping log including a key-value pair corresponding to the code of the source field and the value of the target field.

11. The method of claim 1, further comprises causing, by the one or more processors, a server to upload the second template to at least one layer of a cloud framework.

12. The method of claim 1, further comprising:
receiving, by the one or more processors from a plurality of computing devices, a plurality of templates comprising the plurality of matrices in at least one format;
for each template in the plurality of templates,
loading, by the one or more processors, a queue based on one or more of a size of a template, an estimated time to process the template, a reception time of the template, and a priority assigned to the template; and
executing, by the one or more processors in accordance with the queue, a protocol on a matrix of the plurality of matrices, the protocol to parse the matrix to generate a second source field corresponding to second code and a second target field.

13. The method of claim 1, wherein, the second format comprises at least one of Comma-Separated Values (CSV), JavaScript Object Notation (JSON), Parquet, Avro, Optimized Row Columnar (ORC), or database storage formats accessible using Java Database Connectivity (JDBC).

14. A system of code management, comprising:
one or more processors coupled with memory, the one or more processors configured to:
receive, from a first computing device, a first template comprising a plurality of matrices in a first format to generate a second template in a second format for a second computing device, the first template defining transformation rules for a code associated with the first computing device;
execute a protocol on a first matrix of the plurality of matrices, the protocol configured to parse the first matrix of the plurality of matrices to generate a source field corresponding to the code and a target field;
parse, using the protocol, a second matrix of the plurality of matrices to generate a value for the target field by using the transformation rules on the code of the source field;
generate, using the parsed first matrix and the parsed second matrix, the second template including the value for the target field in the second format used by the second computing device, wherein the value for the target field of the second computing device corresponds to the code of the source field of the first computing device; and
provide the second template in the second format to an external server accessible to the first computing device and the second computing device, the second format mapped to the first format such that the first computing device extracts the value for the target field from the second template.

15. The system of claim 14, wherein the one or more processors are configured to:
verify a source address of the first computing device in accordance with one or more of certificate validation, application programming interface (API) key matching, or encrypted token response; and
in response to successfully verifying the source address, transmit a response to the source address indicating an approval of the first template.

16. The system of claim 15, the one or more processors are configured to prevent the reception of the first template from the first computing device in response to a failure to verify the source address of the first computing device.

17. The system of claim 14, wherein the one or more processors are configured to:
identify a presence of at least one placeholder within the first matrix by use at least one look-up table to identify an empty value in one or more fields of the first matrix; and
identify the code within the one or more fields of the first matrix in accordance with a mapping function.

18. The system of claim 14, wherein the one or more processors are configured to determine a mapping from the source field of the first matrix to the target field of the second matrix using a code history of each matrix stored within a data repository.

19. The system of claim 18, wherein the one or more processors are configured to:
generate the target field in a format defined by the second template based on the mapping;
insert a second value as a placeholder within the target field; and
generate a mapping table that maintains the second value and includes an indication that maps the second value to at least one transformation rule.

20. The system of claim 14, wherein the one or more processors are configured to:
assign the first matrix with an identifier by using one or more of a cryptographic hash, public keys, timestamps, and a version number;
identify an update to the first matrix based on a third template include a third matrix that includes one or more values of a plurality of values within the first matrix and a plurality of placeholders; and
update the first matrix to include the plurality of values and each of the plurality of placeholders of the third matrix.
